(19) United States
(12) Patent Application Publication
(10) Pub. No.: US 2008/0085179 A1
(43) Pub. Date: Apr. 10, 2008

(54) Wind power converting apparatus and method

(75) Inventors: Christopher Piper Toby Kinkaid, Portland, OR (US); Peter L. Coye, Claremont, CA (US)

Correspondence Address: WILLIAM W. HAEFLIGER, 201 S. LAKE AVE, SUITE 512, PASADENA, CA, 91101, US

(73) Assignee: California Energy & Power

(21) Appl. No.: 11/544,433

(22) Filed: Oct. 6, 2006

(51) Int. Cl. F03B 15/06

(52) U.S. Cl. 415/4.1

(57) ABSTRACT

In combination a frame having an upright axis, at least one wind turbine carried by the frame in offset relation to said frame axis, to rotate relative to that axis, at least one baffle oriented by the frame to collect incident wind and re-direct such wind into the turbine.

### BACKGROUND OF THE INVENTION

This invention relates generally to wind turbines, and more particularly to enhancement of the efficiency and power output of such devices by more efficient utilization of wind power.

Wind generators, machines that convert the wind into electrical, mechanical or thermal energy, known in the art are limited to the speed of the wind. The resource of wind is described by those learned in the art as having a power equal to one half the density of the fluid through a swept area times the cube of the fluid's velocity. The important relationship between the speed of the wind, and the power available in the wind at a given wind speed firstly determines the actual productivity of a wind generator.

The wind generator's ability to extract work from the wind describes its power coefficient (Cp). Knowing these two quantities, the power available in the wind (P), and the ability to extract work define the physical outputs of a given wind generator.

Horizontal axis wind turbines often use propellers. Although there are references in prior art of attempts to produce wind concentrating shrouds, barriers and airfoils to divert wind into the device at presumably higher speed to produce more power available for conversion, few attempts have produced any technology that is available or effective. There is need for more efficient usage of available wind.

### SUMMARY OF THE INVENTION

The present invention comprises a process and apparatus that accepts wind from any lateral direction and processes that wind into a shaped stream at higher velocity than the inlet wind speed, thus operating on raw wind to process it into a more useful form: that is controlled direction and increased velocity. This stream is then directed toward the working surface, downwind side of the power converter wind generator, thus optimizing the output of the power converter relative to using unprocessed wind.

Further, the invention operates as a control surface, as by orienting the power conversion elements in the downwind or aft position from the deployment tower or mast. This control further increases the output of the wind generator, as the primary power converter is more available to the wind for optimum operation over time. A significant deficit for propeller based wind conversion devices is their need to follow the wind direction, which is ever changing in real world conditions and locations of deployment. Propellers mounted on a horizontal axis require that the blades be normal in angle to the wind. As wind directions change, propellers are required to yaw into the wind to find that normal orientation. This response time presents a significant time lost to the power converter for wind power conversion.

The present invention acts on indigenous wind by collecting large volumes of raw wind, and processes that wind into a more useful form, in terms of power conversion. The invention processes raw wind into a specific directional vector and at increased velocity. The device of the invention as herein disclosed, is self orienting due the control surface effects when exposed to wind. The device processes the wind by collecting large volumes of raw material, wind, and controls its direction using the Coanda effect, directing a high velocity stream of wind at an angle relative to incidence direction. Wind is accelerated due to use of the Bernoulli principle. The restriction of wind flow produces a high pressure zone and is induced on the collecting side of the device, i.e. that side which is facing the wind. The control surfaces then redirect the impinging moving fluid, using the Coanda effect. This effect essentially describes a moving fluids tendency to follow surfaces in its path.

These Functions Occur Substantially simultaneously from the working surfaces provided, processing wind into a controllable flow direction, with increased velocity. The device of the present invention collects, constricts, increases the fluids speed, and directs that resultant flow into the working side of a vertical axis wind turbine, or equivalent power converter.

Accordingly, a major object of the invention comprises provision of apparatus that includes
a) a frame having an upright axis,
b) at least one wind turbine carried by the frame in offset relation to the frame axis, to rotate relative to that axis,
c) and at least one baffle oriented by the frame to collect incident wind and re-direct such wind into the turbine entrance.

Other objects include provision of two baffles with the frame oriented to concentrate and direct wind flow into two turbines, on the frame; provision of baffles having curvature of wind directing surfaces to accelerate wind flow; the provision of frame pivoting means allowing the apparatus to pivot and head into the oncoming wind; baffle surfaces facing in opposite directions to direct wind flow stream into counter-rotating turbines; turbine vanes oriented to face the oncoming wind streams accelerated by the baffles, and the provision of a preferred wind turbine construction, as will be seen.

These and other objects and advantages of the invention, as well as the details of an illustrative embodiment, will be more fully understood from the following specification and drawings, in which:

### DRAWING DESCRIPTION

FIG. 1 is a schematic perspective view of baffles and wind turbines;

FIG. 2 is a schematic view of wind flow redirection by a curved baffle surface;

FIG. 3 is a view like FIG. 2, but with addition of a wind turbine to which wind flow is directed;

FIG. 4 is a view like FIG. 2, but showing two baffles;

FIG. 5 is a view like FIG. 4, with addition of two wind turbines, and a support frame;

FIG. 6 is a view like FIG. 5, but showing only one wind turbine, receiving wind flow directed by two baffles;

FIG. 7 is a perspective schematic showing two baffles and one wind turbine carried on a pivoted frame;

FIG. 8 is a perspective view of a modified baffle;

FIG. 9 is a schematic view of a wind turbine, with multiple radially extending vanes;

FIG. 10 is a schematic view of a wind turbine with a projecting orientation vane;

FIG. 11 is a view like FIG. 10, showing a modification;

FIG. 12 is a schematic perspective view showing a modified wind orienting vane;

FIG. 13 is a schematic elevation of the FIG. 12 apparatus; and

FIG. 14 is a view showing another wind turbine, in detail.

FIG. 15 is a perspective view showing multiple baffles spaced about a rotating turbine.

### DETAILED DESCRIPTION

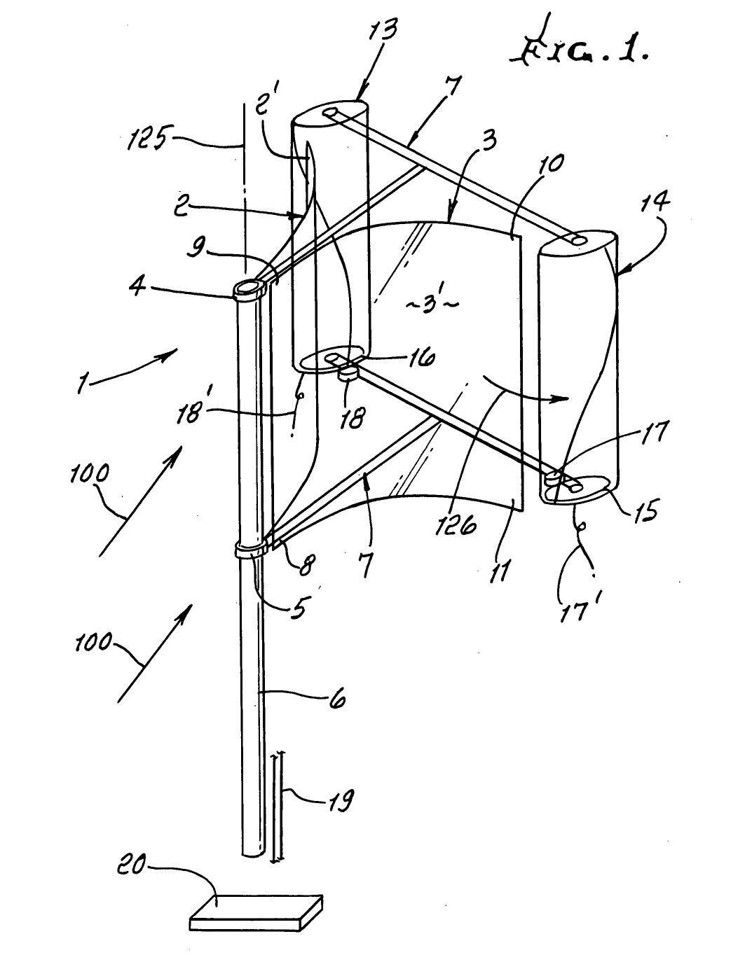

FIG. 1 shows the down-wind, or aft orientation of the preferred device 1. The control surfaces, 2′ and 3′ of baffles 2 and 3 are curved and act on incident wind indicated by arrows 100. The baffles are carried by frame 7 that pivotally reacts to the wind and orients itself aft of the frame pivot bushings 4 and 5 on upright stand 6. Each control surface 2′ and 3′ presents the most stable lowest potential energy position when exposed to wind, as shown. Initial power present in the wind is used for self-orientation. Upon any wind from any other direction impinging on the device, a difference in pressure is experienced along the vertical axis of the mounting stand 6. This uneven pressure on each curved control surface 2′ and 3′ acts to rotate the device about the axis 125 of the stand 6, orienting the device to the most aft position enabled by the frame 7 relative to the pivot bushings 4 and 5. The wind gathered by surfaces 2′ and 3′ is concentrated and respectively supplied to the two wind turbines 13 and 14 carried by frame 7.

The surfaces 2′ and 3′ operate on raw incident wind, or fluid, as by use of the “Coanda” effect, that describes the flow pattern of moving fluids in contact with a surface. The Coanda effect describes how such flows tend to follow the surface due to viscosity increases along the working surface. The curvatures of surfaces 2′ and 3′ each define an arc of a circle embodied in the baffle service extent. Working surfaces 2′ and 3′ are mirror curvatures, that is to say they preferably use the same circular arc extent, pi over 3, or ⅙^{th} of a circle. Surfaces 2′ and 3′ can have a preferred range from pi/2, or 90 degrees of arc, ranging to a small end of pi/4. The arc in the preferred embodiment, is pi/3 as a measure of circular arc extent.

The baffles services 2′ and 3′ have leading edges 8 and 9 positioned along frame 7 to be proximately or just aft of the centered pivot bushings 4 and 5 on 6, as shown. As referred to, concave surfaces 2′ and 3′ exposed to the flow of wing, exert a Coanda effect on the wind, causing the flow to be diverted toward the wind turbines. Using the Bernoulli's principle, the flow of wind is inhibited, causing a high-pressure to build. As in a Venturi effect the incident wind is accelerated from the high-pressure state, at or near convergent surface zones producing a low-pressure high velocity flow exiting the working surfaces 2′ and 3′ at or near their trailing edges 10 and 11 with a wind flow directional vector as at 126, and at increased velocity. The turbines rotate in response to wind incidence, and produce power. Since the turbines are carried by the frame, they rotate with the baffles about the axis 125 of stand 6, to always receive concentrated wind flow.

The working surfaces 2′ and 3′ further operate on or respond to wind, and the ranges and shapes of the working surfaces utilize the Coanda effect to redirect wind vectors towards the curved trailing edges 10 and 11 of the working surfaces. The effect of the working surface geometries is to direct wind in a direction substantively parallel to the tangents of the trailing edges. This causes a venturi effect that accelerates the wind being processed and operates to cause an increase of wind velocity at the trailing edges relative to the inlet wind speed at the leading edges 8 and 9. The operation of wind receiving vertical axis wind turbines, is thereby improved. In this preferred embodiment two vertical axis wind turbines 13 and 14 are mounted to the frame 7 in such manner that the positions of the downstream sides of the turbines, that is to say the relative placements of the outside surfaces of the turbines, in relation to the frame 7 and working baffles 2 and 3, are optimized.

The vertical axis wind turbines typically have power trains 15 and 16 that may for example be gearbox, belt, toothed or other means, to transfer the rotational torque and output horsepower of the turbines into power applied to the shaft or shafts of a suitable alternator, or generator 17 and 18 respectively, or multiples thereof, used to produce electricity for export for the performance of work. See output electrical lines 17′ and 18′ oriented at opposite lateral ends of the frame 7. The wind turbines 13 and 14 typically will rotate in opposite directions, each away from the center of the present invention mounting tower 6, preventing or minimizing net reaction torque application to the frame. As a downward device, but not limited to the downwind deployments, with appropriate control surfaces, such as a tail section, angularly orienting apparatus can be deployed forward of the central axis 125 of tower, pole, or member 6.

Element 19 represents the wire or wires that are either fixed, or by use of yaw brush bushings to transfer electricity to wires down the tower 6, or by use at any point or height in tower 6, electrical power can be transmitted, by these disclosed means and other means known in the art. Wires 17′ and 18′ can be connected to 19. The foundation 20 of stand alone tower 6 may include trussed, segmented, sueged, extendable, fixed, tilt-up, tether, suspended, lifted via lighter than air devices, and other supports for tower 6, poles and deployment arrays.

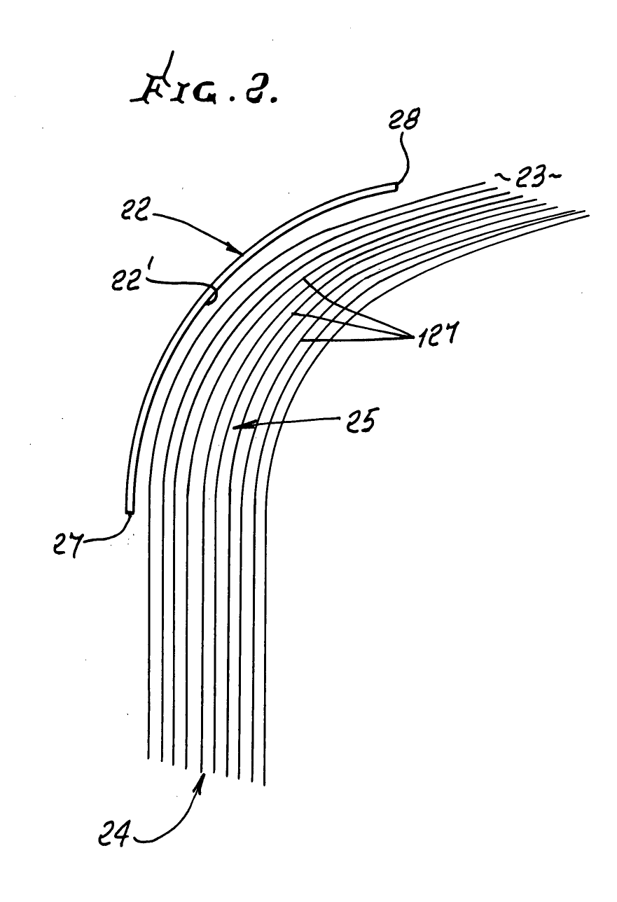

FIG. 2 is a top view of a working surface baffle 22 corresponding to 2 or 3. A flow 24 of moving air, wind, or any other working fluid undergoes a re-directing and concentrating reaction when directed against or toward curved surface 22, in the shape of an arc, such as a segment of a circle. The length of the segment is preferably pi divided by three. The wind 24 is shown flowing upon or toward baffle 22, having a leading edge of 27, and a trailing edge 28. The working baffle surface 22′ acts on the wind, providing viscosity that tends to cause resistance to flow of the layers or streams 127 of moving air, or working fluid, flowing adjacent the working surface 22′, causing in turn the boundary layer of air passing over or adjacent the surface to slow down, initially.

According to Bernoulli's principle, slower fluids have higher internal pressure than faster moving fluids, whereby the high pressure region 25 of flow acts is accelerated following the venturi effect. The result is that baffle 22 has the effect of scooping air into a channel at 23 of higher velocity as the wind exits the baffle past the trailing edge 28. The moving air at 23 experiences a reduced internal pressure as it is accelerated by the baffle. This exhaust wind 23 has increased momentum and presents a higher ram pressure at the turbine intake.

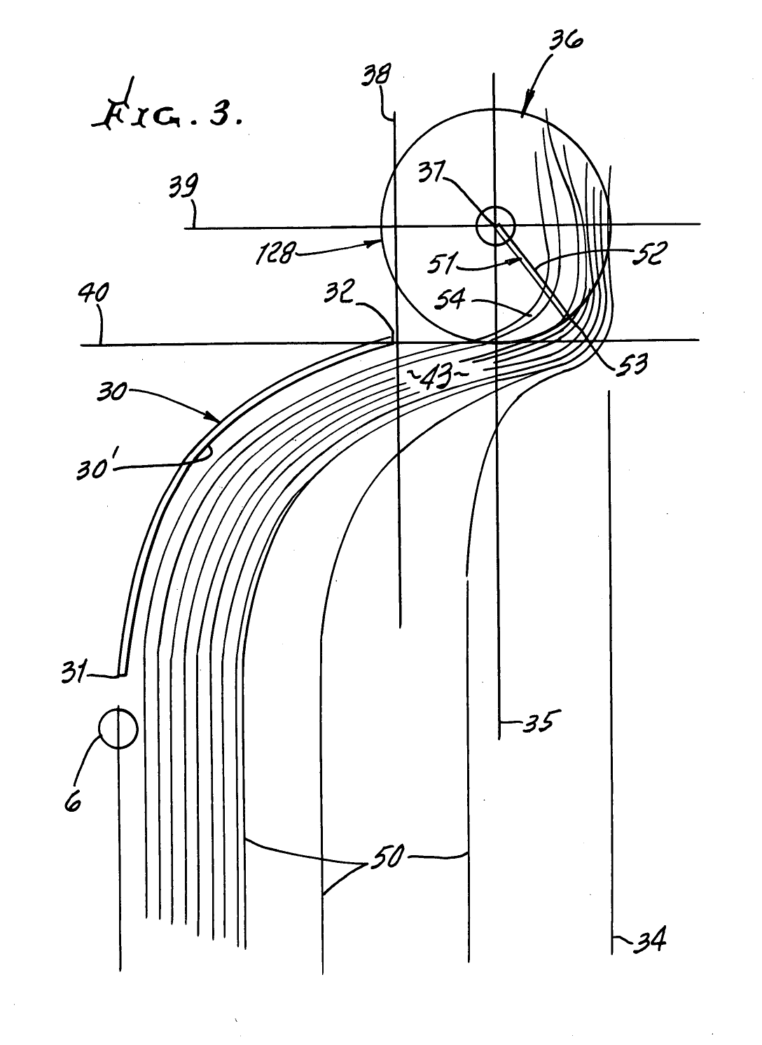

FIG. 3 is a plan view like FIG. 2, showing dynamic isometric lines of wind flow 50 toward the baffle 30. A power converter such as the vertical axis turbine 36 has a wind displaced vane or panel element 51 positioned in the path pf concentrated wind flow 43 off the surface of baffle 30. Impinging wind at 54 is incident upon 51 to produce torque that rotates the turbine 36.

The wind 50 is therefore forced to enter the illustrated flow path at a location closest to the pivot pole 6, to be concentrated by 30 and to be directionally controlled, leaving tangentially, i.e. at the tangent to the trailing edge 32 with induced increased velocity due to the effect of the control surface 30′ of baffle 30.

A suitable power converter, preferably a vertical axis wind turbine 36, is shown in top view with a center axis 37. The turbine has one or more vanes 51 that rotate around the center longitudinal axis point 37. The present invention improves the torque producing performance of all such vanes as compared to unprocessed (i.e. non-concentrated) raw wind.

Flow is directed approximately tangentially and at the midpoint between the vanes center point 52 and the end point 53 of the vane. This approximate midpoint between points 52 and 53 intersects line 35 normal to the tangent line 40 extending from trailing edge point 32, during turbine rotation. Line 39 is an orthogonal line perpendicular to the center line 35 that extents longitudinally and parallel to the path of the impinging wind 50, and both lines 34 and 39 [pass through the turbine axis 37. The region between lines 38 and 35 indicate the turbine and vane regions shielded from the onrush of raw impinging wind due to turbine configuration.

The trailing edge point 32 of the baffle 30 lies along the tangential line 40 and orthogonal line 38 as shown. The baffle 30 partially shades or masks the upstream side at 128 of the power converter, as power converter vane 51 rotates about the center axis 37. A distance of ⅛^{th} to ⅕^{th} of the radial extent of vane arm 51 is shielded from the original direction of the impinging wind. This shading of the furthest part of the power converter vane swept-area increases the difference of forces experienced by the vane in the upstream side of the cycle, compared to the downstream side.

The upstream side of the path of the power converter vane 51 as related to the shading function of baffle 30 operates to lower the resistance to upstream rotation of vane 51. Reducing this outermost resistance to vane member 51 rotation provides a greater “delta” in drag between each vertical half of the working vane 51, considering that the greater the delta, or difference each half (upstream and downstream side) experiences in the wind, the greater the ability to extract work from the wind, enhancing the effectiveness of the present invention.

Further, the downstream side of the vane rotation cycle benefits from the increase in swept area exposed to impinging wind or moving fluid, the vane being impacted by the accelerated wind resulting from functioning of the baffle 31. The resultant force vectors of the exiting wind flow 43 are directed toward the zone 54 between the midpoint 52 of vane 51 and the endpoint 53. As referred to, control of the direction vector flow at 43 of exit wind is provided by alignment of tangential line 40 at the exit trailing edge point 32 tangent point at the intersection of device 35 with the periphery of the turbine.

Further, impinging moving air, or other fluid 50 is acted upon as referred to above, by using Bernoulli's principle, and by operating of the working surface 30′ of baffle 30 to induce a high pressure zone 42. Forced to follow the concave working surface 30′, using the Coanda Effect, impinging wind, or other working fluid flow across or between the swept area baffle endpoints 31 and 32, the wind 50 is impeded, accelerated, and directed by the surface 30′ resulting in an air scooping channel of accelerated working fluid. This increases the momentum of the working fluid and imparts an increased ram pressure against the power converter represented here by vane, or vanes 51. The result is a significant increase in power that can be extracted from the wind, as compared to a power converter exposed to unprocessed wind 50.

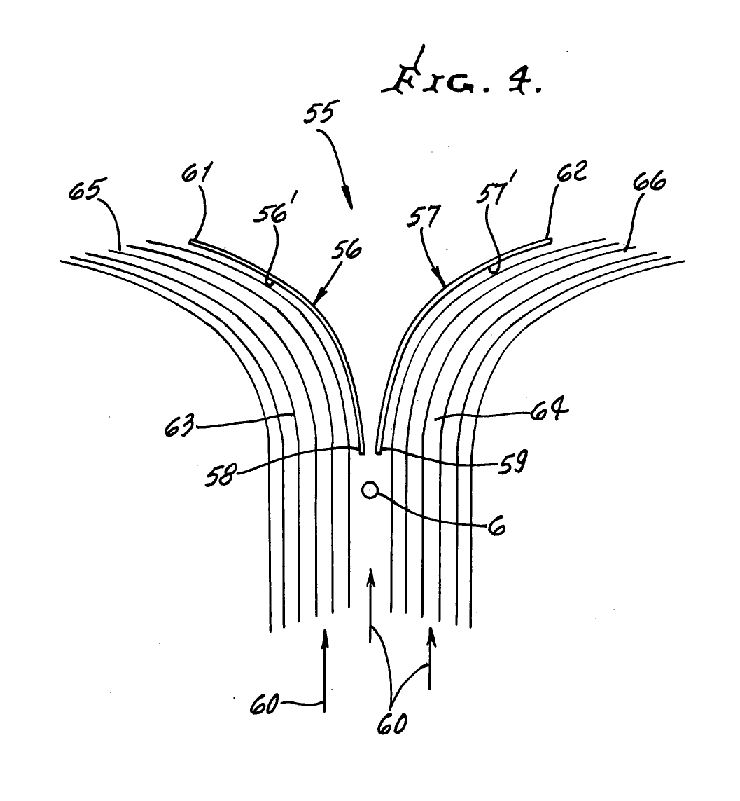

FIG. 4 is a top-view 55 of a bi-directional air scooping and accelerating preferred embodiment of the present invention that uses two oppositely curving baffles 56 and 57 oriented as described above, with adjacent leading edge points 58 and 59 most forwardly presented toward the center pivot of stand 6 as described. Impinging fluid is captured and concentrated at 65 and 66 across the lateral swept areas extending from baffle exit endpoint trailing edges 61 and 62. Impinging working fluid 60 interacts with the concave working surfaces of baffles 56 and 57, as described above, inducing a change in direction and increased relative velocity of the working fluid. Due to impact with the working surfaces, relative high pressure zones 63 and 64 are induced, respectively.

The Coanda effect is operative, and the flow basically follows the concave curvatures of the working surfaces 56′ and 57′ of 56 and 57, and the flow exits in two differing directions as shown. The exit direction vectors of the wind, or working fluid, will follow the tangential lines extending from exit points 61 and 62. These exit flows will be at higher velocities than that of the original impinging working fluid 60.

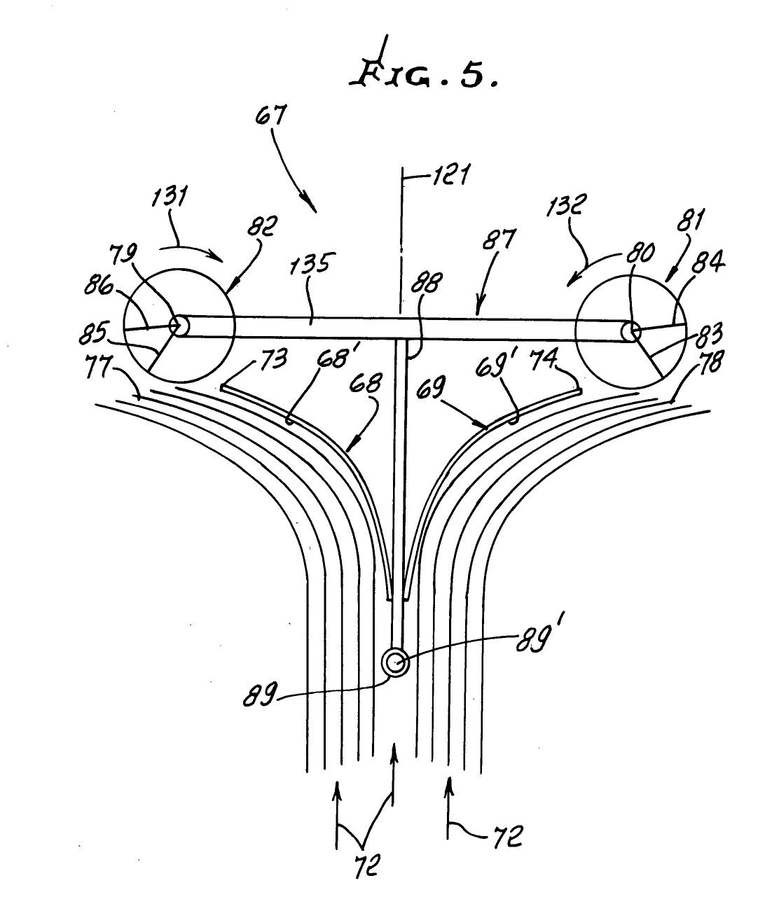

In FIG. 5, the top-view 67 relates flow to production or extraction of work. Working surfaces 68′ and 69′ of baffles 68 and 69 are mirror configurations, rotated about a center line 121 which is longitudinal and parallel with the wind 72. The surfaces are formed as concave segments of circular arcs. The surface curvature extent formula is preferred to range from pi divided by 2 to pi divided by 12, with a further preferred value within that range of pi divided by 3, using polar coordinates.

This 60 degree arc of a circle, pi/3 enables use of advanced materials such as polyethylene, composites and other known materials that can be blow molded, cast, roto-molded, injection molded and other know means of fabrication of said materials, to form the working surfaces that process the wind as specified.

As disclosed, when the apparatus is rotated, by the wind to head into the wind, exhaust wind at 77 leaving from baffle 68 endpoint 73, and exhaust wind 78 leaving baffle 69 trailing point 74 respectively, effectively separate the impinging wind 72 into two opposite flow groups or halves 77 and 78 respectively.

Vertical axis power converters 82 and 81 having center axis points 79 and 80 respectively, are positioned by baffle support frame 87, as shown and described above in FIG. 3. This FIG. 5 view 67 shows the counter revolutions (see arrows 131 and 132) of the respective power converters 82 and 81. Vane element 83 moves down stream toward position 84; and vane element 85 moves down stream, toward position 86.

Frame element 87 is configured as a chassis that is or may be populated with elements described, such as the working surfaces 68′ and 69′, and power converters 82 and 81′. These elements and others are suitably attached to the frame.

The frame includes an orthogonal member 88 that extends from the cross piece 135 to the support tower or stand 89 that houses the bushings 89′ enabled frame rotating. The frame supports the two wind turbines 81 and 82 as shown.

By virtue of the symmetry of 73 and 74, and 81 and 82, in FIG. 5 the member 88 will orient itself down stream in the most aft position, being the position of least resistance.

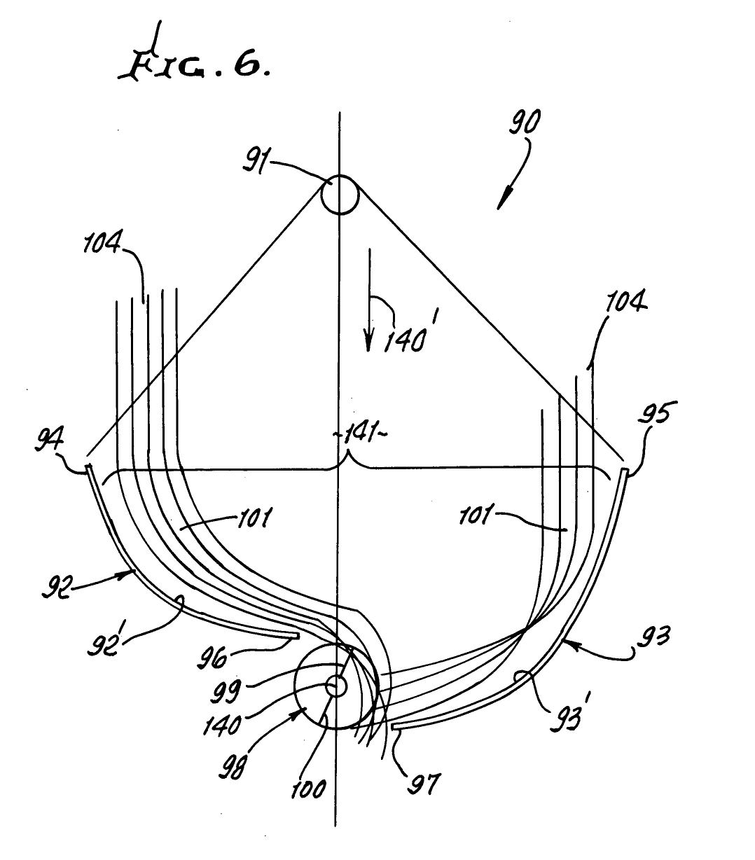

View 90 in FIG. 6 is a top plan view of a dual working baffle surface secondarily preferred embodiment driving a single vertical axis wind turbine 98. Shown is a deployment tower or stand 91 and a top view of the working (wind gathering baffles 92 and 93) surfaces 92′ and 93′. The working surface 92′ has and lateral entrance point 94 with an endpoint 96 mounted with the orientation to the vertical axis wind turbine as described earlier. The other working surface 93′ has an entrance point 95 and an exit point 97. This baffle 93 is set further aft than the other baffle 92 by a distance of one diameter of the vertical axis turbine 98 swept area of the rotor vane or vanes represented by 99 and 100 with a center axis at 140.

The functions of the two working surfaces 92′ and 93′ are to work in concert with impinging wind 104 which is captured by the working surfaces, shown here in two dimensions, across (i.e. at 141) the entrance points 94 and 95. Wind is captured between these entrance points 94 and 95. These working surfaces 92′ and 93′ are scalable, larger or smaller than the diameter of the vertical axis turbine 98 used as the principle power converter, as long as the specific positioning of 92 and 93 above is maintained.

Impinging wind 104 from any direction will first act to orient the device to a down wind or aft position relative to the mounting tower, or pole 91. Next the impinging wind 104 is captured and concentrated by the working surfaces 92′ and 93′, as shown. A high pressure zone 101 is induced following Bernoulli's principle, causing an acceleration of the working fluid flow along the curved working surfaces 92 and 93, producing increased flow velocity as the flow exits the working baffles 92 and 93 in directions tangential to the exit points 96 and 97 respectively.

As the device orients (by wind force exertion on the like baffles) to the aft position, the center axis 140 lines up with the direction of the wind (see arrow 140) and directly aft of the center point of the support tower 91. In this orientation, impinging wind streams 104 are controlled to exit across the forward and rear vanes 99 and 100 of the rotary power converter (wind turbine and generator). The working surface 92′ produces a stream of controlled working fluid into the forward exposed working side of the vertical axis wind turbine vane 99. The other working surface 93 produces a flow of working fluid in the opposite direction as from baffle 92. The result produces a ram pressure on opposite ends of the vertical axis turbine working vane(s) 99 and 100. This results in an increase in power that can be extracted from the vertical axis wind power converter, as fluid dynamic forces are directed simultaneously to both working sides of the swept area of the working vanes 99 and 100 through their cycles.

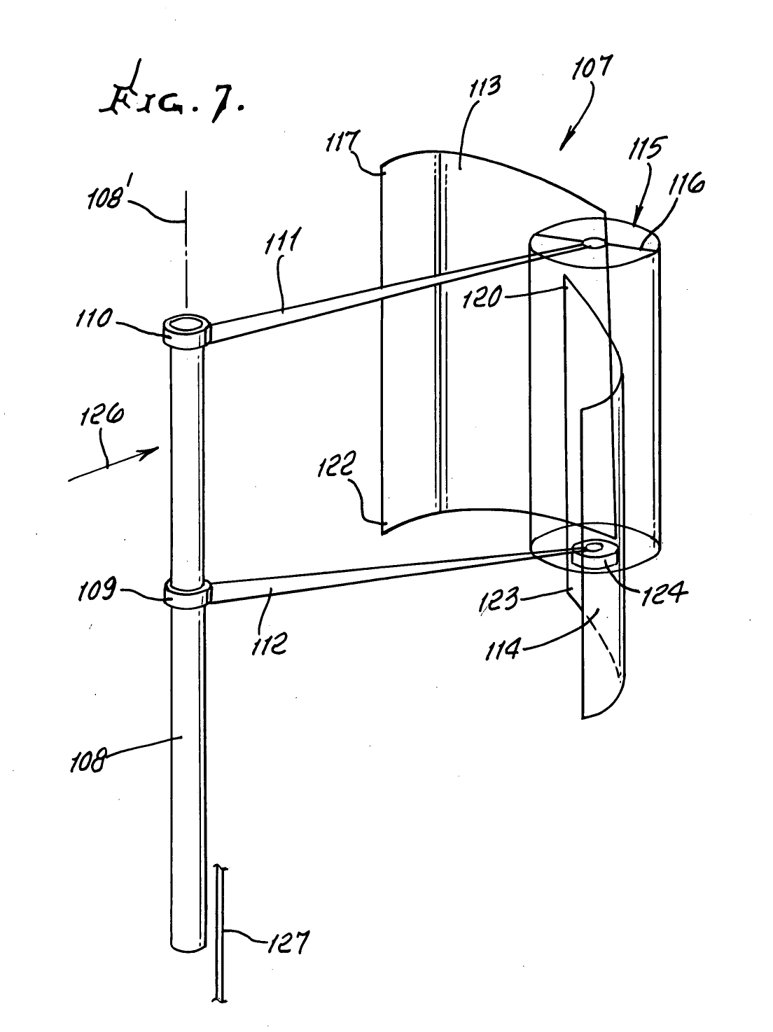

View 107 on FIG. 7 shows the present invention in another preferred embodiment. A longitudinally upright center post, or tower 108 deploys the device. The tower is equipped with two bushings 109 and 110 allowing a 360 degree range of motion. A frame with lateral elements 111 and 112 extends from the bushings 110 and 109 to support the working elements. This frame assembly allows a full range of swinging motion, enabling the device to turn into the wind from any lateral direction, provided the means for self-orientation, as uneven wind forces on either side of the device exert uneven forces, until the device is oriented into the least resistance position, which is aft of the support pole 108. Arcuate working surfaces 113 and 114 operate on impinging wind as described above, by capturing, accelerating, and directing the working toward the rotary working surfaces of a single vertical axis wind turbine 115.

Working surface 114 directs the winds, or working fluids flow toward end points 120 and 123 tangentially toward the rotating forward part of the vertical axis wind turbine 115 that is closest to the mounting pole 108. Working surface 113 is oppositely deployed, about the vertical axis 108′ of tower 108 such that wind flow 126 entering toward the working surface 113 across upper and lower entrance points 117 and 122 is collected, accelerated and directed by working surface 113, to exit the working surface tangentially at 122 and 123 toward the most aft part of the swept area of the vertical axis 115 wind turbine. In this way the apparatus captures raw wind, or moving fluid, bisects that flow into two flows exiting the respective working surfaces 113 and 114 toward the vertical axis wind turbine, 115, or other suitable power converter.

The vertical axis wind turbine 115 has a working vane or vanes 116 that rotate about the center vertical axis of the turbine 115. This produces a ram force on two sides of the wind turbine 115 increasing the power available for conversion. An electrical power converter 124 is connected mechanically to the rotating vane or vanes 116 of the power converter 115 and is converted into electrical energy for the application of work. Wires that distribute this electrical current to a load are represented at 127, on 108.

View 129 in FIG. 8 is a perspective of an additional element that provides yet another preferred embodiment of the present invention. The working surface, 133 is shown curved as generally described above. Entering wind, or working fluid 132 impinges on the working surface 133. Additional flanged working surfaces 130 and 131 respectively are attached to project orthogonally to the working surface 133. Beginning with the entrance point 134 and ending with the exit point 140. The additional working surfaces or flanges 130 and 131 extends lengthwise along the surface 133 and extends or protrudes perpendicularly to the surface 133 as by a distance ranging from 1/64^{th} of the width distance, between the entrance edge points 134 and 135 to ⅙^{th} the this distance, with a preferred distance of 1/12^{th}. Wind flow or other fluid flow 132 impinging on the surface 133 is redirected (using the Coanda effect) and is accelerated at to the Venturi effect and Bernoulli's principle. This accelerated fluid 136 is then ejected across the endpoints 140 and 139, respectively. The exit working fluid 137 has been concentrated and channeled by the surface 133, and the additional orthogonal surfaces 130 and 131, acting to channel the flow into the desired direction toward a turbine, with increased velocity, by cooperation of these disclosed surfaces. The additional curved surfaces 130 and 131 work in concert with the primary surface 133 to capture, accelerate, and direct impinging fluids 132 into a more desired concentrated flow form 137 of known direction, tangential to the exit surface defined by endpoints 140 and 139, and at increased velocity when compared to the entrance impinging wind 132.

Therefore, the invention disclosed herein improves the wind power conversion into a form or forms for supply to power conversion means, to be effectively converted into extractable work.

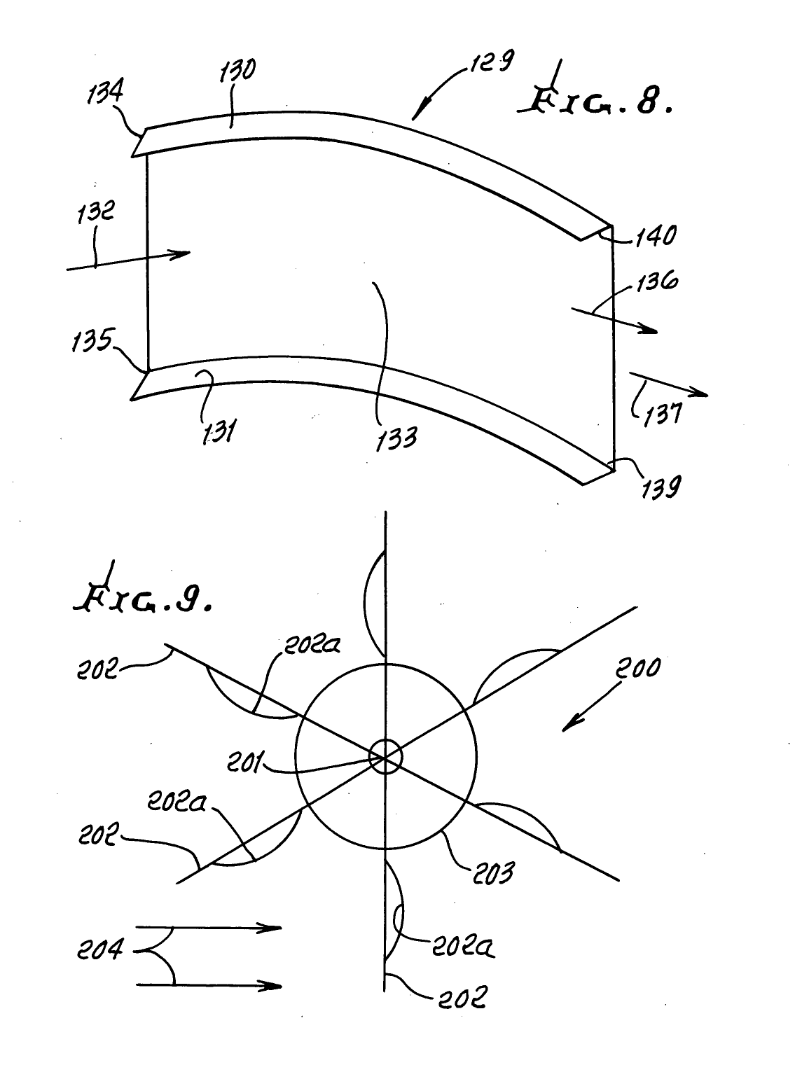

FIG. 9 shows wind turbine 200 having an axis 201 of rotation, and multiple radially extending vanes 202 on a rotor 203. Wind flow 204 off a baffle as at 129 in FIG. 9, impinges on the vanes to rotate the turbine rotor 203. The vanes have wind flow catching pockets 202a.

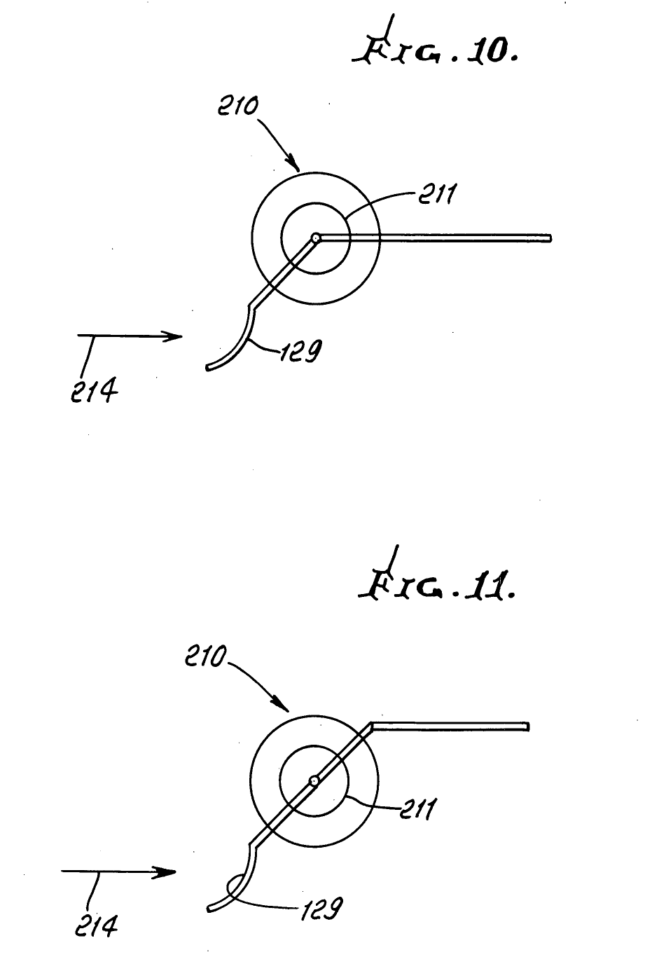

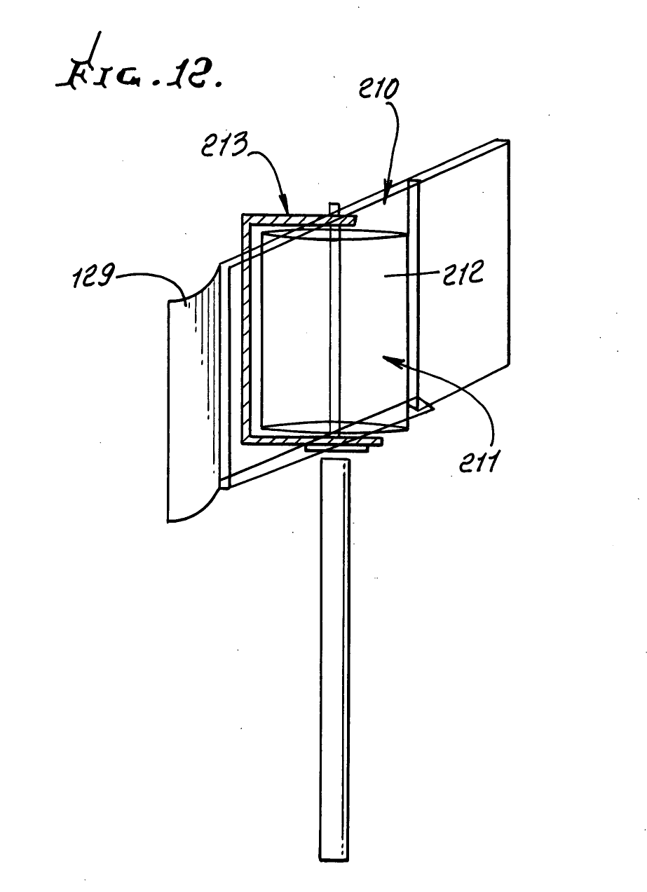

FIG. 10 shows a wind flow driven turbine 210 with a rotor 211, and a rotor vane 212. Structure 213 supports the turbine, in the path of flow 214 off a baffle as described herein. FIG. 11 is similar.

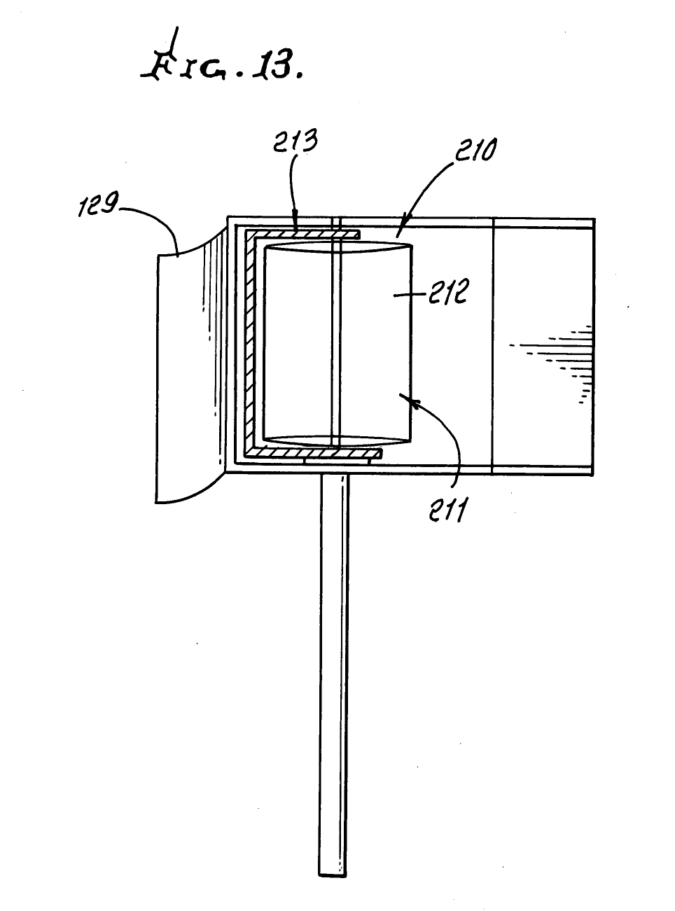

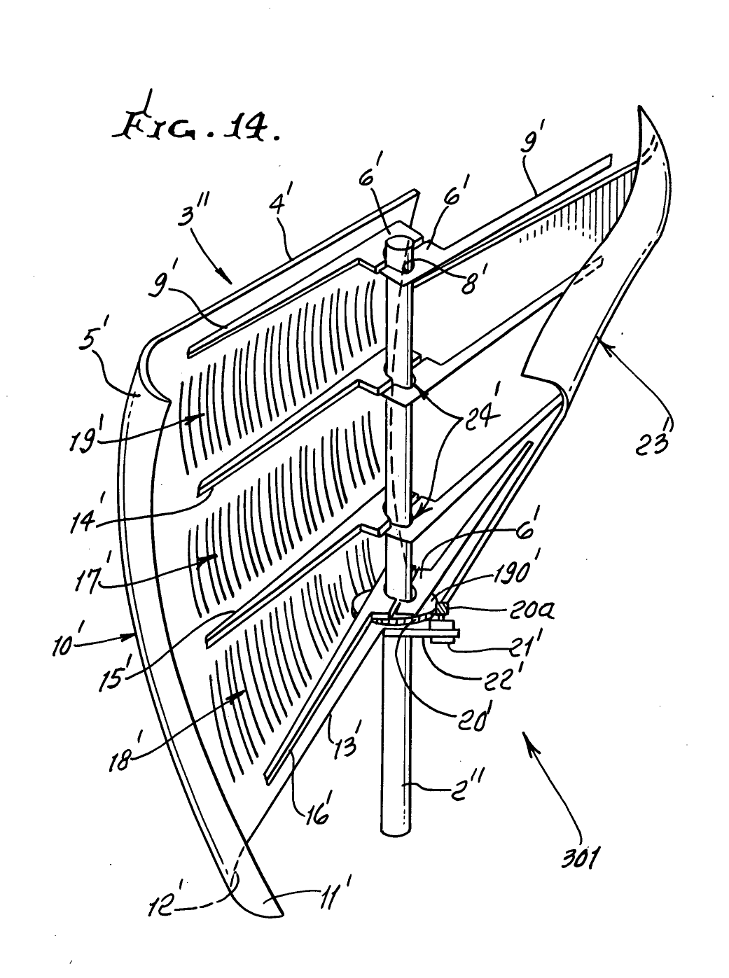

FIGS. 12 and 13 are schematics showing elements as in FIGS. 10 and 11.

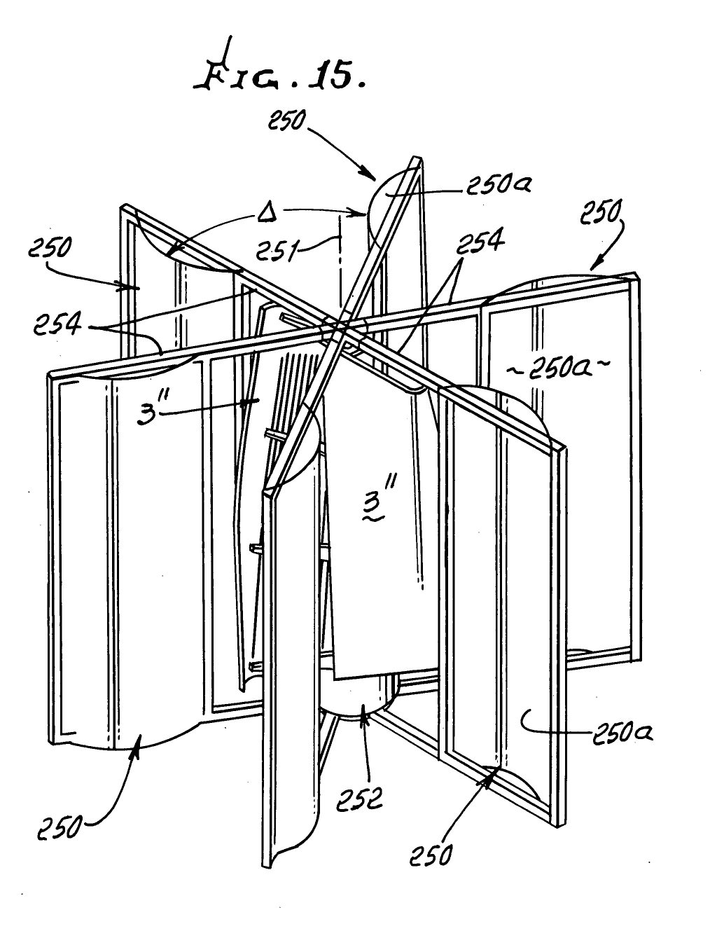

The turbine 301 shown in FIG. 14 comprises a shaft post 2′ extending upright or at other angle, depending on orientation to which the apparatus is attached and deployed in the field. Single element blade, or wing sections 3′ are deployed as shown. They may be molded by roto-molding, or injection molding, or other known molding techniques. Wing elements or sections 3′ are attached to the main support shaft 2′ symmetrically, in pairs or higher numbers by employing a molded rib element or elements 9′, 14′, 15′ and 16′ integrated into the wing element

The wing element 3′ comprises a straight section 4′ terminating transversely at an arc section 5′ of a circle to be described in detail below. Preferably, the arc extends through an angle from about 105 to 125 degrees. The structure 4′ and 5′ of wing or blade section 3′ is twisted over the upright length 10′ of the wing by an angle of about pi/3 which is about 60 degrees. This turning angle may be from 15 to 89 degrees, with 60 degrees as a general preferred embodiment. Thus, the lowermost portion of each blade or wing section is offset, azimuthally relative to the uppermost portion of each blade. The turning angle starts at the top of the wing straight section 4′ and extends through to the bottom of the wing indicated at 13′, having terminal arc section 11′. Integrated into the single wing section 3′ are the support rib elements 9′, 14′, 15′ and 16′, these being spaced apart as shown. A plurality of baffles are also integrated into the wing section 3′. These are shown at 17′, 18′ and 19, in three laterally extending rows, the baffles spaced apart and extending generally upright. The baffles may extend in the space through the length of the wing element from top to bottom.

The baffles 17′-19′ and grooves therebetween provide additional wind resistance on the downwind side of the wing element providing more grip and therefore more extraction of impulse from the moving air upon the working surfaces. The bifacial wing element 3′ performs several simultaneous functions. It has an enhanced ability to extract impulse from the wind by maximizing its resistance to the wind on the down stream side of the element when the wind impinges from various obtuse angles. The element has an un-textured and smooth upstream side to minimize resistance to the wind as the wing or blades rotate 360 degrees per cycle, or turn as viewed from center axis of rotation about the support shaft 2′. The wing elements with generally horizontal ribs 9′, 14′, 15′ and 16′ integrated and protruding from the wing element working surfaces produce a high tensional strength sturdy wing element 3′. The rotational azimuthally turned angle from the top to bottom of the wing element adds structural integrity to the element, and strength for survivability in high wind speed environments.

The rib elements 9′, 14′, 15′ and 16′ provide an efficient means for bracketing the wing elements to the center shaft 2′. The plurality of baffles 17′-19′ also provide structural integrity to the molded wing element and great strength, giving further enhanced utility to the apparatus, especially in high wind speeds. Usable plastic materials include high density polyethylene, polypropylene and other equivalent materials.

The device provides a method for choosing revolutions per minute rates for given wind speeds and wind zone areas. Lower average wind zones enable use of a shorter blade height to width ratio, i.e. less than one, to provide a longer moment arm and produce more torque at low revolutions per minute and low wind speeds. Conversely, a higher height to width ratio, greater than one, provides higher revolutions per minute but with less torque. Variations in dimensions of the apparatus enable optimization of power output, conversion efficiencies as turned to the actual site specific characteristics of the wind resource, and the provision of hardware to extract useful work. A preferred height to width ratio is phi, approximately 1.618, also referred to as the golden section. Height to width ratio can be adjusted.

The bottom of the wing 3′ working surface follows the same lateral configuration as the top, starting with a laterally straight section 13′, and terminating at an arc section 12′. The azimuth turning angle extends from the top straight section 4′ to the bottom straight section 13′, This turning angle can be within a range from 15-89 degrees. Using a 15 degree turning angle allows presentation of more blade surface area to the wind at any given moment and is suitable for low wind speed sites. Using an 89 degree turning angle is desirable for high wind speed sites. For a general case, about 60 degrees of turning angle is preferred. The rib sections 9′, 14′, 15′ and 16′, of each wing section 3′ and 231, when assembled, wrap around seating bearings 24′ that are affixed to the support shaft 2′, the wing sections or blades 10 and 23 being alike. The ribs on the blades terminate at integral plates 6′ that are assembled by suitable fastening, to embrace the post at plate defined holes 8.

Attached to the bottom bracket defined by plates 6′ integral with bottom ribs 16′ of the two blades is a power rotor 190′ that is comprised of a spur gear or friction roller 20′ that translates the motion of the blades or wing elements 31 and 23′ into a uniform circular motion transferred to spur gear 20′. Gear 20′ turns the shaft of a power converter such as a direct current generator, permanent magnet alternator or other mechanical or electrical power converter 21′ supported by a mounting bracket 221 that attaches to the support shaft 2′.

FIG. 15 shows multiple wind collecting and concentrating baffles, as for example six like baffles 250 projecting at equal angular intervals A about the axis 251 of rotating turbine 252. That turbine may be like the turbines shown in FIG. 14 having two wing or blade section 3′ rotating along paths radially inwardly of the six baffles 250 to receive wind collected and directed inwardly by the concave curved surfaces 250a of the baffles. Frame elements 254 project generally radially relative to axis 251, and carry the baffles to remain stationary as the turbine rotates.

Accordingly, flow of wind from any direction is re-directed into the turbine. Such baffles are also oriented to block wind from striking the drag or slip portions of the turbines.

I claim:

1. In combination
a) a frame having an upright axis,
b) at least one wind turbine carried by the frame in offset relation to said frame axis, to rotate relative to that axis,
d) at least one baffle oriented by the frame to collect incident wind and re-direct such wind into the turbine.

2. The combination of claim 1 wherein there are two baffles that have wind flow re-directing surfaces which have curvatures in the directions of wind flow toward the turbine.

3. The combination of claim 2 wherein said curvature defines substantially a segment of a circle.

4. The combination of claim 2 wherein said curvature is characterized as inducing acceleration of wind flow toward the wind turbine or turbines.

5. The combination of claim 1 including means mounting the frame to pivot about said upright axis, in response to wind impingement on the baffle or baffles.

6. The combination of claim 5 including a grid vane carried by the frame to pivot the frame in response to wind impingement on the grid vane whereby the baffles are directed to collect incident wind.

7. The combination of claim 2 wherein each wind turbine has a vane that projects crosswise of the direction of wind flow leaving the baffle flow re-directing surface, to receive impinging of that flow.

8. The combination of claim 2 wherein said baffle surface curvatures face in generally opposite directions.

9. The combination of claim 8 wherein said wind turbines have generally parallel axes of rotation and said turbines are oriented relative to said baffle surfaces to rotate in said opposite directions.

10. The combination of claim 2 wherein said wind turbine has first and second vanes, the first vane projects crosswise of the direction of wind flow leaving one baffle flow re-directing surface, and the second vane projecting crosswise of the direction of wind flow leaving the other baffle flow re-directing surface.

11. The combination of claim 2 wherein said wind flow re-directing surfaces have channel shaped cross sections.

12. The combination of claim 1 wherein each turbine comprises:
a)′ an upright shaft defining an upright axis,
b)′ at least two blades operatively connected to the shaft to rotate about the shaft axis as the blades are wind driven about said axis,
c)′ the lowermost portion of each blade being offset, azimuthally, relative to the uppermost portion of each blade,
d)′ baffles carried by the blades to project directionally to receive impingement of wind for creating torque transmitted to the blade to effect blade rotation about said axis.

13. The combination of claim 12 wherein each turbine comprises:
a)′ an upright shaft defining an upright axis,
b)′ at least two blades operatively connected to the shaft to rotate about the shaft axis as the blades are wind driven about said axis,
c)′ the lowermost portion of each blade being offset, azimuthally, relative to the uppermost portion of each blade,
d)′ baffles carried by the blades to project directionally to receive impingement of wind for creating torque transmitted to the blades to effect blade rotation about said axis.

14. The combination of claim 1 wherein there are multiple wind concentrating baffles spaced about said axis to collect incident wind and to direct such wind into the rotating turbine.

15. The combination of claim 14 wherein there are six of said baffles spaced about said axis.

16. The combination of claim 14 wherein the baffles are stationary and have curved surfaces for collecting and directing wind into the turbine.

17. The combination of claim 16 wherein the baffles are carried to project at substantially equal angular intervals about said axis.

18. The combination of claim 18 wherein there are multiple wind concentrating baffles spaced about said axis to collect incident wind and to direct such wind into the rotating turbine.

19. The combination of claim 18 wherein the baffles have curved surfaces for collecting and directing wind onto the rotating turbine blades.

20. The combination of claim 19 wherein the baffles are carried to project at substantially equal angular intervals about said axis.
